(19) United States
(12) Patent Application Publication
(10) Pub. No.: US 2004/0231468 A1
(43) Pub. Date: Nov. 25, 2004

(54) Hand or automatic driven tool for attaching screwed anchors

(76) Inventor: Mark Odachowski, Ocean City, MD (US)

Correspondence Address: LARRY J. GUFFEY, WORLD TRADE CENER - SUITE 1800, 401 EAST PRATT STREET, BALTIMORE, MD, 21202, US

(21) Appl. No.: 10/444,732

(22) Filed: May 23, 2003

(51) Int. Cl. B25B 13/00

(52) U.S. Cl. 81/58.1

(57) ABSTRACT

A tool for inserting screwed, anchoring devices, with the tool being capable of being operated manually or automatically, comprises an elongated handle, a shaft that extends between the ends of said handle with a tip end that extends from the front end of the handle and a distal end that lies in the rear end of the handle. The rear end of the shaft has a well that extends along the centerline of the shaft, with the well being configured to receive a standard drill bit of the type that fits within the chuck of a power drill. The depth and wall thickness of the well are such that the well allows a drill bit to enter the well to a depth so that there is ample surface area of the well interior wall in contact with the drill bit to absorb the torque applied to the tool by the power drill. The tip end of the shaft may be configured to attach to one of the anchoring devices, or it may be configured with a well for receiving any one of a number of screw bits that may be used with the tool to insert an anchor which has a head configuration that matches that of the screw bit. Anchoring devices suitable for use with this tool include screws, bolts, nuts, and socketed devices.

### DESCRIPTION OF THE PREFERRED EMBODIMENT

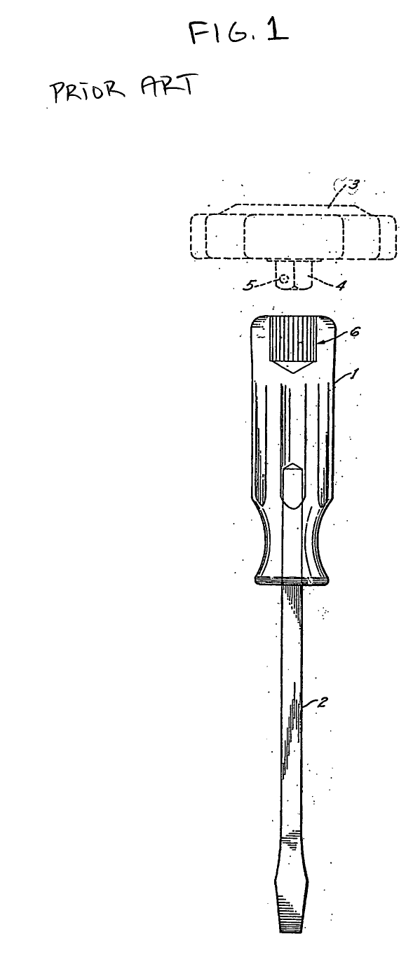

Referring now to the drawings wherein are shown preferred embodiments and wherein like reference numerals designate like elements throughout, there is shown in FIG. 3 a perspective view of an embodiment of the present invention in the form of an improved screwdriver 1 which has been modified so that it can easily be driven by using a standard screwdriver drill bit 2 with a conventional, cordless power drill 3.

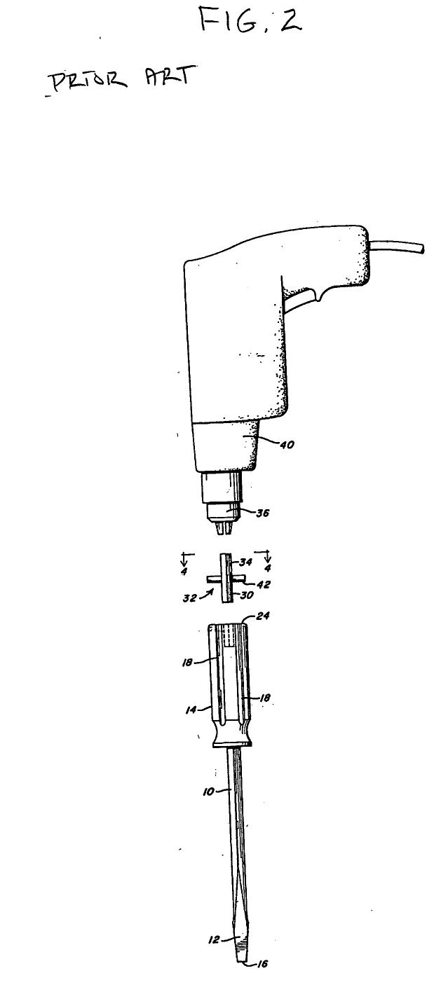

This improved screwdriver 1 includes a shaft 10 and a handle 12. The shaft 10 has a tip end 14 and extends all the way through the handle so as to have a distal end 16 that is flush with the handle's end surface 18. The tip 14 shown in FIG. 3 has a straight or knife edge 20 designed to engage a single slotted head of a screw. However, it will be appreciated that the tip 14 may take other forms such as, for example, that intended to engage the cross slot of a PHILLIPS head screw. See FIG. 4 for illustrative examples of various types of screw heads 4 that can be driven by various embodiments of the present invention.

This screwdriver's handle 12 may be provided with axially extending grooves 22 on its surface to enable the handle to be gripped conveniently by the user. These handles will usually be molded of plastic or other like material.

The distal end 16 of the shaft extension has a well 24 within it that is configured to receive the end of a standard drill bit 5, such as any of those shown on the right side of FIG. 4. The depth of this well is such that it can allow the bit to enter the well to a depth so that there is ample surface area of the well interior wall in contact with the drill bit to absorb with little deformation the larger torques applied by a power drill. To aid in holding a drill bit, which is typically made of steel and is an iron containing material, in place within this well 24, the distal end 16 of the shaft can be magnetized so that it will magnetically attract an iron containing drill bit. If the shaft is of a magnetizable material, this can be accomplished by magnetizing the shaft directly. If not, a suitably shaped magnet can be placed in proximity to the shaft's distal end 16. Similarly, the tip end 14 of the shaft 10 can be magnetized to aid in holding iron-containing screws or other anchors on the shaft's tip.

The shaft of this embodiment of a screwdriver according to the present invention has a tube-like screwguide 26 that encircles the shaft 10 in such a manner that the shaft of the screwdriver 1 can rotate freely within this screwguide 26 while the screwguide itself is held stationary. The screwguide 26 also can be moved laterally on the shaft 10. This screwguide is used to guide screws into place as the screwdriver 1 is powered by a drill.

To use this screwguide 26, one places a screw on the tip 14 of the shaft 10 and then slides the screwguide forward to enclose the screw. One then places a hand on the outer surface of the screwguide 26 to hold it stationary, thereby stabilizing the position of both the screw and the screwdriver 1.

When power it applied to the handle's distal end 16, the shaft 10 turns and drives the screw forward as it is held in place by the screwguide 26 until it is fully anchored in its desired location. This screwguide 26 is also seen to serve the safety purpose of preventing a misaligned screw on the tip 14 of the screwdriver from being thrown off line and possibly even launched sideways, so as to become a threat to those in the area, when a large amount of torque and a high rotation rate are applied to the screw. If the tip end 14 of the shaft 10 has been magnetized, the choice of the material for the construction of the screwguide 26 will be made so that the screwguide is not attracted by the magnetic properties of the shaft's tip end 14.

To aide the further versatility of such a screwdriver, another preferred embodiment of the present invention consists of a screwdriver similar to that described above, but having a tip end 14 that is configured so that it can accommodate any one of a number of multiple ends or screw bits. For example, if the tip end 14 has a hexagonal shaped well in its tip, it can interchangeably accommodate any of the screw drivers or drill bits 5 shown on the right hand side in FIG. 4. To aid in holding such drivers in place, the tip end 14 would also be magnetized.

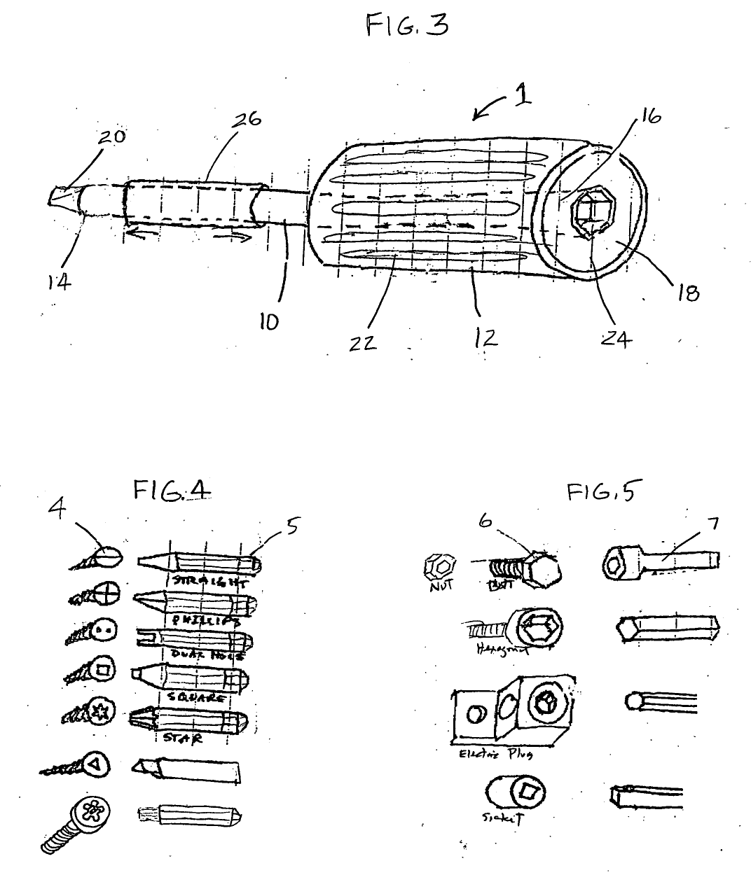

To make it easy to keep up with various driver or drill bits 5, another embodiment of the present invention has a handle which has slots 15 around the perimeter of its front 17 face. These slots 15 are configured so as to accommodate and allow one of the various driver bits to be inserted and stored within each of the slots. See FIG. 6.

In addition to performing as a screwdriver, this device can easily be made to perform as a nut or other type of driver by configuring the tip 14 of the shaft 10 so that it can mate with various types of nuts, bolts or sockets. Again, the tip can be magnetized to aide in holding an anchor on the tip. Some of the types of drivers 7 that can be used with this device are shown on the right side of FIG. 5, while shown on the left side of are the various bolts, nuts, sockets 6, etc. that can be inserted with these drivers.

For various low torque applications, it may be desirable to configure these devices so that they consist not of a single shaft which extends all the way thorough the handle, but to insert into the end surface 18 of the handle 12 a metal insert 28 which has within it an especially configured, magnetized well 24 for receiving a standard drill bit. See FIG. 7.

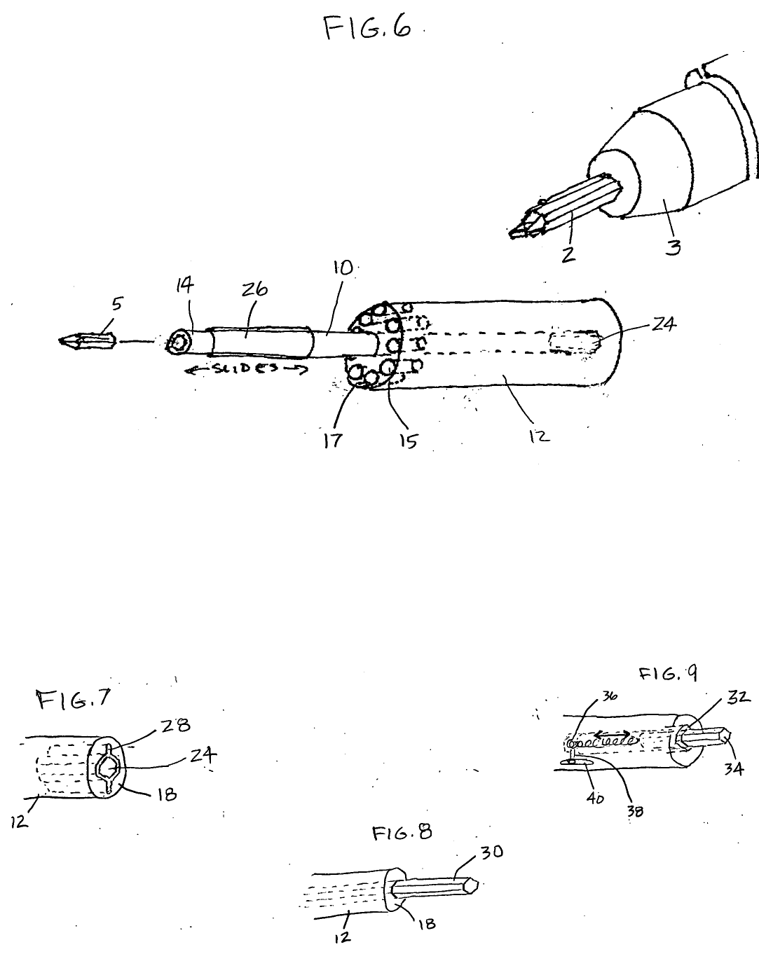

It should also be noted, that for some specialized applications, it may be desirable to configure these devices so that they have a male shaft adapter 30 that extends from the handle's end surface 18 rather than have the well 24, or female adapter, at the distal end 16 of the shaft 12. In such an embodiment, this adapter 30 would be configured so that it could be directly accommodated and fit within the chuck of a standard electric drill. See FIG. 8.

In still other applications, it may be desirable to configure the present invention into another embodiment in which the shaft does not extends all the way thorough the handle. This embodiments has an insert 32 which contains an especially configured, male, pop-out adapter 34. See FIG. 9. The insert 32 also has a spring mechanism 36 which is operable by an extension 38 that extends to a location 40 on the outer surface of the handle 12 and serves to make the adapter 34 interchangeable between a first and a second position. In its first position, this adapter 34 extends from the handle 12, and in its second position, the adapter is retracted into the insert 32. In its first position, this adapter is easily fitted within the chuck of an electric drill, while in its second or retracted position, the adapter does not interfere with a user who wishes to grip the device by its handle and use it, without the aid of an electric drill, to install a screw anchor.

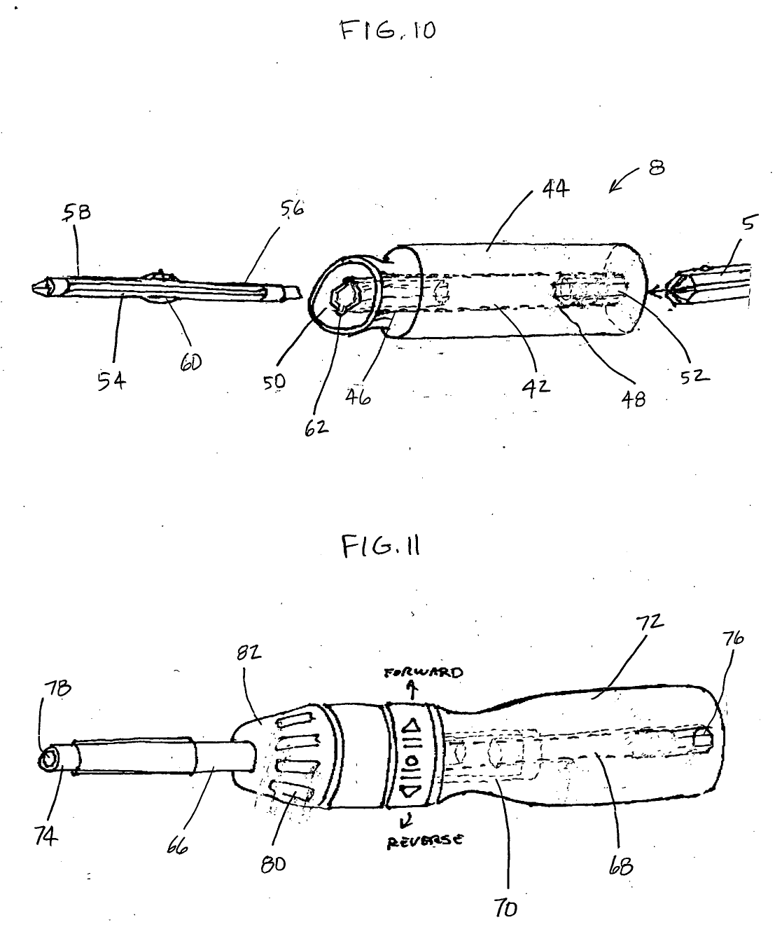

Another preferred embodiment of a driver device 8 having multiple tip interchangeable capability is shown in FIG. 10. It consists of a shaft 42 and a handle 44. The shaft 42 has front 46 and rear 48 ends. Each of these has an especially configured well 50, 52.

The rear end well 52, as before, is configured to receive the end of a standard drill bit 2, such as any of those shown on the right side of FIG. 4. The depth of this well 52 is such that it can allow the bit to enter the well to a depth so that there is ample surface area of the well interior wall in contact with the drill bit so as to absorb with little deformation the larger torques applied by a power drill. To aid in holding a drill bit in place within this well 52, the rear end 48 of the shaft can be magnetized so that it will magnetically attract an iron containing drill bit.

The front end well 50 is configured to receive the rear end 56 of any one of a number of interchangeable shaft extensions 54. Again, the depth and wall thickness of this well 50 is chosen so as to accommodate the expected torque to be applied by the device. Both the front 58 and the rear 56 ends of these extensions 54 are configured in the form of a driver head which is to be used to drive a specific type of screw or anchor, such as those shown in FIG. 4. These ends will preferably be magnetized to aid in holding iron-containing screws or other anchors on either of the extension's tips.

For higher torque applications, a portion of length of the shaft extension 54 can have one or more ribs 60. With such an extension, the front well 50 would then be configured so as to have matching slots 62 to accommodate the ribs 60 so that the extension 54 can still fit within the front well 50.

For even more versatility, an embodiment of the present invention is provided with a two piece shaft 66, 68 and a clutching mechanism 70 in the handle 72 which enables the tip 74 of the front portion 66 of the shaft to be rotated in either a forward, for inserting a screw anchor, or a reverse, for withdrawing a screw anchor, mode of operation. The rear portion 68 of this shaft again has a well 76 in its rear end so that it can be driven by the insertion of the bit of an electric drill. This embodiment is also provided with the ability to fit multiple types of bits into a well 78 that exists on the tip of the front portion of the shaft. It has storage slots 80 on the front face 82 of the handle 72 for storage of the various bits that can be used with the device. See FIG. 11.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention as hereinafter set forth in the claims.

1. A tool for inserting screwed, anchoring devices, said tool capable of being operated manually or automatically with the use of a power drill having a chuck which holds a two-portion driver bit, said tool comprising:
a plurality of two-portion driver bits, each of said bits having a head portion and a driver portion, wherein said driver portion having a cross section adapted to fit within said chuck and said head portion adapted to mate with a fastener having a top portion with a drivable-recess whose configuration is selected from the group consisting of designs denoted as slotted, PHILLIPS, dual-hole, square, star, hexagonal, triangular or TORX,
an elongated handle having a front end and a rear end and a centerline therebetween,
a shaft having a tip end and a distal end and a centerline therebetween,
said shaft extending between the ends of said handle such that said shaft and handle centerlines coincide,
said shaft tip end extending between the front end of said handle, and
a well extending along said handle centerline
said well having a depth extending forwardly from a rear end,
said well configured to receive said head portion and a specified extent of said driver portion of one of said plurality of two-portion driver bits
said specified extent of said driver portion being such that the surface area of said well can absorb the torque applied to said tool by said power drill when said drill drives one of said two-portion driver bits placed within said well so as to rotate said well and tool about said centerline.

2. A tool as recited in claim 1, wherein said shaft tip end configured to attach to the head of one of said screwed anchoring devices.

3. A tool as recited in claim 2, further comprising a screwguide having a tip end and a rear end, said screwguide configured so as to encircle a portion of the length of said shaft that extends from said handle front ends and mounted so as to allow said shaft to rotate within said screwguide and to allow said screwguide to slide on said shaft between a first position and a second position, wherein when said screwguide is in said first position said screwguide tip end fits around a to-be-insert screwed anchor so as to hold said anchor in place while said anchor is being screwed into place, wherein when said screwguide is in said second position said screwguide tip end is retracted towards said handle front end so as to fully expose said shaft tip end.

4. A tool as recited in claim 3, wherein a portion of said well is magnetized so as to aide in retaining a one of said plurality of diver bits that is inserted into said wall.

5. A tool as recited in claim 4, wherein said shaft tip end is magnetized so as to aide in retaining an anchor that is placed on said shaft tip end.

6. A tool as recited in claim 5, wherein a screwed anchoring device suitable for use with said tool is chosen from the group consisting of screws, bolts, nuts, and socketed devices.

7. A tool as recited in claim 1, wherein said shaft tip end having a tip end well that is configured so as to receive any one of a number of screw bits that may be used with said tool to insert a screwed anchor which has a head configuration that matches that of said screw bit and is chosen from among the group consisting of screw head designs denoted as slotted, PHILLIPS, dual-hole, square, star, hexagonal, triangular, or TORX.

8. A tool as recited in claim 7, further comprising a screw guide having a tip end and a rear end, said screwguide configured so as to encircle a portion of the length of said shaft that extends from said handle front end, and mounted so as to allow said shaft to rotate within said screwguide and to allow said screwguide to slide on said shaft between a first position and a second position, wherein when said screwguide is in said first position said screwguide tip end fits around a to-be-insert screwed anchor so as to hold said anchor in place while said anchor is being screwed into place, wherein when said screwguide is in said second position said screwguide tip end is, retracted towards said handle front end so as to fully expose said shaft tip end.

9. A tool as recited in claim 8, wherein a portion of said shaft rear end well is magnetized so as to aide in retaining one of said plurality of driver bits that is placed in well.

10. A tool as recited in claim 9, wherein a portion of said shaft tip end well is magnetized so as to aide in retaining a drill screw bit that is placed in said shaft tip end well.

11. A tool as recited in claim 10, wherein said shaft handle front end having a slot configured to store a screw bit of the kind that is suitable for insertion into said shaft tip end well.

12. A tool as recited in claim 11, wherein a screwed anchoring device suitable for use with said tool is chosen from the group consisting of screws, bolts, nuts, and socketed devices.

13. A tool for inserting screwed, anchoring devices, said tool capable of being operated manually or automatically, said tool comprising:
an elongated handle having a front end and a rear end,
a shaft having a tip end and a distal end,
wherein said handle is mounted on a portion of said shaft that includes said distal end and allows a portion of said shaft proximate said tip end to extend from said front end of said handle, and
an elongated insert that is mounted in the rear end of said handle, said insert having a longitudinal axis that aligns with the centerline of said shaft, said insert having a well that extends along the centerline of said insert, said well configured to receive a standard drill hit of the type that fits within the chuck of a power drill, the depth and wall thickness of said well being such that the well allows a drill bit to enter said well to a depth so that the surface area of the well interior wall in contact with said drill bit can absorb the torque applied to said tool by said power drill.

14. A tool as recited in claim 13, wherein said shaft tip end configured to attach to the head of one of said screwed, anchoring devices.

15. A tool as recited in Claim 14, wherein a screwed anchoring device suitable for use with said tool is chosen from the group consisting of screws, bolts, nuts, and socketed devices.

16. A tool as recited in claim 15, further comprising a screwguide having a tip end and a rear end, said screwguide configured so as to encircle a portion of the length of said shaft that extends from said handle front end, and mounted so as to allow said shaft to rotate within said screwguide and to allow said screwguide to Glide on said shaft between a first position and a second position, wherein when said screwguide is in said first position said screwguide tip end fits around a to-be-insert anchor so as to hold said anchor in place while said anchor is being screwed into place, wherein when said screwguide is in said second position said screwguide tip end is retracted towards said handle front end so as to fully expose said shaft tip end.

17. A tool as recited in claim 16, wherein a portion of said insert is magnetized so as to aide in retaining a drill bit that is inserted into said insert well.

18. A tool as recited in claim 17, wherein a portion of said shaft tip end is magnetized so as to aide in retaining an anchor that is placed on said shaft tip end.

19. A tool for inserting screwed, anchoring devices, said tool capable of being operated manually or automatically, said tool comprising:
an elongated handle having a front end and a rear end,
a shaft having a tip end and a distal end, said shaft extending between the ends of said handle with said tip end extending from the front end of said handle and said distal end extending from the rear end of said handle, and
said distal end of said shaft configured so as to allow said end to fit within the chuck of a power drill.

20. A tool as recited in claim 19, wherein said shaft tip end configured to attach to the head of one of said screwed, anchoring devices.

21. A tool as recited in claim 20, wherein a screwed anchoring device suitable for use with said tool is chosen from the group consisting of screws, bolts, nuts, and socketed devices.

22. A tool as recited in claim 21, further comprising a screwguide having a tip end and a rear end, said screwguide configured so as to encircle a portion of the length of said shaft that extends from said handle front end, and mounted so as to allow said shaft to rotate within said screwguide and to allow said screwguide to slide on said shaft between a first position and a second position, wherein when said screwguide is in said first position said screwguide tip end fits around a to-be-insert anchor so as to hold said anchor in place while said anchor is being screwed into place, wherein when said screwguide is in said second position said screwguide tip end is retracted towards said handle front end so as to fully expose said shaft tip end.

23. A tool as recited in claim 22, wherein a portion of said shaft tip end is magnetized so as to said in retaining all anchor that is placed on said shaft tip end.

24. A tool for inserting screwed, anchoring devices, said tool capable of being operated manually or automatically, said tool comprising:
an elongated handle having a front end and a rear end,
a shaft having a tip end and a distal end,
wherein said handle is mounted on a portion of said shaft that includes said distal end and allows a portion of said shaft proximate said tip end to extend from said front end of said handle,
an elongated insert that is mounted in the rear end of said handle, said insert having a longitudinal axis that aligns with the centerline of said shaft and an outer end and an inner end, said insert outer end lying in close proximity to said handle rear end, said insert having a well that extends from said insert outer end and along a portion of the centerline of said insert,
an adapter slidably mounted within said well, said adapter having an inward end and an outward end, said outward end configured so as to allow said outward end to fit within the chuck of a power drill, and
a spring mechanism mounted within the bottom of said well, said mechanism having a front end and a rear end, with said mechanism front end contacting the rear end of said adapter, said mechanism serving to move said adapter between a first position in which the outward end of said adapter is in close proximity to said handle rear end and a second position in which the outward end of said adapter extends from said well so that said end can be clamped onto by the chuck of a power drill.

25. A tool as recited in claim 24, wherein said shaft tip end configured to attach to the head of one of said screwed, anchoring devices.

26. A tool as recited in claim 25, wherein a screwed anchoring device suitable for use with said tool is chosen from the group consisting of screws, bolts, nuts, and socketed devices.

27. A tool as recited in claim 26, further comprising a screwguide having a tip end and a rear end, said screwguide configured so as to encircle a portion of the length of said shaft that extends from said handle front end, and mounted so as to allow said shaft to rotate within said screwguide and to allow said screwguide to slide on said shaft between a first position and a second position, wherein when said screwguide is in said first position said screwguide tip end fits around a to be insert anchor so as to hold said anchor in place while said anchor is being screwed into place, wherein when said screwguide is in said second position said screwguide tip end is retracted towards said handle front end so as to fully expose said shaft tip end.

28. A tool as recited in claim 27, wherein a portion of said shaft tip end is magnetized so as to aide in retaining an anchor that is placed on said shaft tip end.

29. A tool fit inserting strewed, anchoring devices, said tool capable of being operated manually or automatically, said tool comprising:
an elongated handle having a front end and a rear end,
a shaft extending through and along the axis of said handle, said shaft having a tip end and a distal end, with said tip end lying in close proximity to said handle front end, and said shaft distal end lying in close proximity to said handle rear end,
said shaft having a rear well that extends from said shaft distal end and along a portion of the centerline of said shaft, said rear well configured to receive a standard drill bit of the type that fits within the chuck of a power drill, the depth and wall thickness of said rear well being such that the well allows a drill bit to enter said well to a depth so that the surface area of the well interior wall in contact with said drill bit can absorb the torque applied to said tool by said power drill, and
said shaft having a tip well that extends from said shaft tip end and along a portion of the centerline of said shaft, said tip well configured to receive a shaft extension of the type having a driver head that is used to drive a specific type of anchoring device.

30. A tool as recited in claim 29, further comprising a shaft extension having a rear end and a head end, said rear end configured so as to slidably fit within said shaft tip well, said head end configured so as to mate with the head of one of said screwed anchoring devices so as to drive said anchor into a position where it is desired that said anchor be located.

31. A tool as recited in claim 30, wherein a portion of said shaft extension head end is magnetized so as to aide in retaining an anchor that is placed on said shaft extension head end.

32. A tool for inserting screwed, anchoring devices, said tool capable of being operated manually or automatically, said tool comprising:
an elongated handle having a front end and a rear end,
a first shaft it mounted in the rear end of said handle, said first shaft having a longitudinal axis that aligns with the centerline of said handle, said first shaft having a rear end and a connecting end, said first shaft rear end lying in close proximity to the rear end of said handle, said first shaft having a well that extends from said shaft rear end and along, the centerline of said shaft, said well configured to receive a standard drill bit of the type that fits within the chuck of a power drill, the depth and wall thickness of said well being such that the well allows a drill bit to enter said well to a depth so that the surface area of the well interior wall in contact with said drill bit can absorb the torque applied to said tool by said power drill,
a second shaft having a tip end and a distal connecting end, said second shaft being rotatably mounted along the centerline of said handle such that a portion of said second shaft in proximity to said tip end extends from the front end of said handle, said second shaft distal connecting end lying in proximity to the connecting end of said first shaft,
a means for clutching that connects said connecting ends of said shafts, said clutching means operable between a first and a second position, wherein when in said first position said clutching means enables said first and second shafts to rotate together, wherein when in said second position said clutching means enables said first and second shafts to rotate in opposite directions.

33. A tool as recited in claim 32, wherein said second shaft tip end configured to attach to the head of one of said screwed, anchoring devices.

34. A tool as recited in claim 33, wherein a screwed anchoring device suitable for use with said tool is chosen from the group consisting of screws, bolts, nuts, and socketed devices.

35. A tool as recited in claim 34, further comprising a screwguide having a tip end and a rear end, said screwguide configured so as to encircle a portion of the length of said second shaft that extends from said handle front end, and mounted so as to allow said second shaft to rotate within said screwguide and to allow said screwguide to slide on said second shaft between a first position and a second position, wherein when said screwguide is in said first position said screwguide tip end fits around a to-be-insert anchor so as to hold said anchor in place while said anchor is being screwed into place, wherein when said screwguide is in said second position said screwguide tip end is retracted towards said handle front end so as to fully expose said second shaft tip end.

36. A tool as recited in claim 35, wherein a portion of said well is magnetized so as to aide in retaining a drill bit that is inserted into said well.

37. A tool as recited in claim 36, wherein a portion of said second shaft tip end is magnetized so as to aide in retaining an anchor that is placed on said second shaft tip end.

38. A tool as recited in claim 32, wherein said second shaft tip end having a well that is configured so as to receive any one of a number of screw bits that maybe used with said tool to insert a screwed anchor which has a head configuration that matches that of said screw bit and is chosen from among the many various designs for said screw heads.

39. A tool as recited in claim 38, wherein a screwed anchoring device suitable for use with said tool is chosen from the group consisting of screws, bolts, nuts, and socketed devices.

40. A tool as recited in Claim 39, further comprising a screwguide having a tip end and a rear end, said screwguide configured so as to encircle a portion of the length of said second shaft that extends from said handle front end, and mounted so as to allow said second shaft to rotate within said screwguide and to allow said screwguide to slide on said second shaft between a first position and a second position, wherein when said screwguide is in said first position said screwguide tip end fits around a to-be-insert anchor so as to hold said anchor in place while said anchor is being screwed into place, wherein when said screwguide is in said second position said screwguide tip end is retracted towards said handle front end so as to fully expose said second shaft tip end.

41. A tool as recited in claim 40, wherein a portion of said first shaft well is magnetized so as to aide in retaining a drill bit that is inserted into said well.

42. A tool as recited in Claim 41, wherein a portion of said second shaft well is magnetized so as to aide in retaining a drill bit that is placed on said second shaft well.

43. A tool for inserting screwed, anchoring devices, said tool capable of being operated manually or automatically with the use of a power drill having a chuck which can hold a driver bit, sad tool comprising:
an elongated handle having a front end and a rear end and a centerline therebetween,
a shaft having a tip end and a distal end and a centerline therebetween,
said shaft extending between the ends of said handle such that said shaft and handle centerlines coincide,
said shaft tip end extending from the front end of said handle, and a well extending along said handle centerline,
said well having a depth extending forwardly from a rear end,
said well configured to receive any one of a plurality of two-portion driver bits, each of said bits having a head portion and a driver portion, wherein said driver portion having a cross section adapted to fit within said chuck and said head portion adapted to mate with a screw fastener having a top portion with a drivable-recess whose configuration is selected from the group consisting of designs denoted as slotted, PHILLIPS, dual-hole, square, star, hexagonal, triangular or TORX,
said well depth being such that said well can accept said bit head portion while also accepting a sufficient length of said bit driver portion so as to enable the surface area of said well adjacent said driver portion to absorb the torque applied to said tool by said power drill when said drill drives one of said two-portion driver bits when said bit is placed within said well so as to rotate said well and tool about said centerline.

44. A tool as recited in claim 43, wherein said shaft tip end configured to attach to the head of one of said screwed, anchoring devices.

45. A tool as recited in claim 44, further comprising a screwguide having a tip end and a rear end, said screwguide configured so as to encircle a portion of the length of said shaft that extends from said handle front end, and mounted so as to allow said shaft to rotate within said screwguide and to allow said screwguide to slide oil said shaft between a first position and a second position, wherein when said screwguide is in said first position said screwguide tip end fits around a to-be-insert screwed anchor so as to hold said anchor in place while said anchor is being screwed into place, wherein when said screwguide is in said second position said screwguide tip end is retracted towards said handle front end so as to fully expose said shaft tip end.

46. A tool as recited in claim 45, wherein a portion of said well is magnetized so as to aide in retaining one of said plurality of driver bits that is inserted into said well.

47. A tool as recited in claim 46, wherein said sit tip end is magnetized so as to aide in retaining an anchor that is placed on said shaft tip end.

48. A tool as recited in claim 47, wherein a screwed anchoring device suitable for use with said tool is chosen from the group consisting of screws, bolts, nuts, and socketed devices.

49. A tool as recited in claim 43, wherein said shaft tip end having a tip end well that is configured so as to receive any one of a number of screw bits that may be used with said tool to insert a screwed anchor which has a head configuration that matches that of said screw bit and is chosen from among the group consisting of screw head designs denoted as slotted, PHILLIPS, dual-hole, square, star, hexagonal, triangular, or TORX.

50. A tool as recited in claim 49, further comprising a screw guide having a tip end and a rear end, said screwguide configured so as to encircle a portion of the length of said shaft that extends from said handle front end, and mounted so as to allow said shaft to rotate within said screwguide and to allow said screwguide to slide on said shaft between a first position and a second position, wherein when said screwguide is in said first position said screwguide tip end fits around a to-be-insert screwed anchor so as to hold said anchor in place while said anchor is being screwed into place, wherein when said screwguide is in said second position said screwguide tip end is retracted towards said handle front end so as to fully expose said shaft tip end.

51. A tool as recited in claim 50, wherein a portion of said well is magnetized so as to aide in retaining one of said plurality of driver bits that is placed in said well.

52. A tool as recited in claim 51, wherein a portion of said shaft tip end well is magnetized so as to aide in retaining a screw bit that is placed in said shaft tip end well.

53. A tool as recited in claim 52, wherein said shaft handle front end having a slot configured to store a screw bit of the kind that is suitable for insertion into said shaft tip end well.

54. A tool as recited in claim 53, wherein a screwed anchoring device suitable for use with said tool is chosen from the group consisting of screws, bolts, nuts, and socketed devices.
